(19) United States
(12) Patent Application Publication
(10) Pub. No.: US 2026/0018995 A1
(43) Pub. Date: Jan. 15, 2026

(54) POWER SUPPLY CIRCUIT AND ELECTRONIC APPARATUS

(71) Applicant: Lenovo (Singapore) Pte. Ltd., Singapore (SG)

(72) Inventors: Limin Xiao, Kanagawa (JP); Moriyuki Tsuchihashi, Kanagawa (JP); Kazuo Fujii, Kanagawa (JP)

(73) Assignee: Lenovo (Singapore) Pte. Ltd., Singapore (SG)

(21) Appl. No.: 19/256,793

(22) Filed: Jul. 1, 2025

(30) Foreign Application Priority Data
Jul. 9, 2024 (JP) 2024-110501

(51) Int. Cl. H02M 3/07

(52) U.S. Cl. CPC H02M 3/07

(57) ABSTRACT

A power supply circuit that converts a single input voltage to a multi-stage output voltage, includes: one or more switched capacitors capable of transforming the input voltage at one or more transformation ratios and applying a lower transformation ratio as the input voltage increases; and a regulator that adjusts an intermediate voltage based on an output power from the switched capacitor to the output voltage.

### CROSS-REFERENCE TO RELATED APPLICATIONS

This application claims priority to Japanese Patent Application No. 2024-110501 filed on Jul. 9, 2024, the contents of which are hereby incorporated herein by reference in their entirety.

### TECHNICAL FIELD

The present application relates to a power supply circuit and an apparatus, including an electronic circuit that converts a single DC power into power having a plurality of different voltages.

### BACKGROUND

Electronic apparatuses such as personal computers (PCs) include many electronic components, and each electronic component requires power having a different voltage. Such an information apparatus has a power supply circuit that converts the power supplied from a power supply into a plurality of multi-stage voltages and outputs power having the converted voltages. The power supply circuit includes multiple circuit elements such as a DC converter and a regulator. These circuit elements may be integrated into a power management integrated circuit (PMIC).

Japanese Unexamined Patent Application Publication No. 2020-140426, for example, describes an information processing apparatus that has a power supply unit that supplies power to each unit based on the power supplied from a built-in battery or an AC adapter, and controls charging of the built-in battery based on the power supplied from the AC adapter. The power supply unit includes a PMIC, and detects and controls the charging voltage and charging current, and also controls turning the power supply to each unit on and off.

Some PMICs have multiple output rails capable of outputting power with different output voltages. In general, the greater the voltage difference between input and output, the lower the voltage conversion efficiency tends to be. The conversion efficiency tends to be lower in step-up than in step-down. Therefore, it is difficult to improve the conversion efficiency for all output voltages from a single input voltage. The PMIC may be supplied with power discharged from a battery, not limited to the power supplied from a commercial power source via an AC adapter. In this case, the input voltage may vary significantly depending on the battery configuration or a change in remaining charge of the battery. This makes optimization of the conversion efficiency more difficult.

A power supply circuit according to the first aspect of the present application converts a single input voltage to a multi-stage output voltage, and the power supply circuit includes: one or more switched capacitors capable of transforming the input voltage at one or more transformation ratios and applying a lower transformation ratio as the input voltage increases; and one or more regulators that adjust an intermediate voltage based on an output power from each of the switched capacitors to the output voltage.

In the above power supply circuit, the one or more of switched capacitors may include: a first switched capacitor capable of stepping up the input voltage at a predetermined step-up ratio; and a second switched capacitor capable of stepping down the input voltage at a predetermined step-down ratio, wherein the first switched capacitor may step up the input voltage when the input voltage is lower than a predetermined first reference voltage, and the second switched capacitor may step down the input voltage when the input voltage is higher than a predetermined second reference voltage, and the one or more of regulators may include: a first regulator that adjusts a first intermediate voltage based on a first output power from the first switched capacitor to a first output voltage as a part of the output voltage; and a second regulator that adjusts a second intermediate voltage based on a second output power from the second switched capacitor to a second output voltage as another part of the output voltage.

In the power supply circuit, the input voltage may be the discharge voltage of a battery, and each of the switched capacitors may set the transformation ratio based on a configuration of the battery.

The power supply circuit may further include: a step-down converter that steps down a second output power from the second switched capacitor, or a step-up converter that steps up a first output power from the first switched capacitor.

In the power supply circuit, the one or more of switched capacitors and the one or more regulators may be integrated.

An electronic apparatus according to the second aspect of the present application includes a battery and the above-described power supply circuit.

One or more embodiments of the present application improve the conversion efficiency from a single input voltage to a plurality of different output voltages.

### BRIEF DESCRIPTION OF THE DRAWINGS

FIG. 1 is a block diagram illustrating one example of the configuration of a power supply circuit according to one or more embodiments.

FIG. 2 is a block diagram illustrating a first configuration example of the logic PMIC according to one or more embodiments.

FIG. 3 is a block diagram illustrating a second configuration example of the logic PMIC according to one or more embodiments.

FIG. 4 illustrates a first example of the operation of a switched capacitor according to one or more embodiments.

FIG. 5 illustrates a second example of the operation of a switched capacitor according to one or more embodiments.

FIG. 6 illustrates a third example of the operation of a switched capacitor according to one or more embodiments.

FIG. 7 illustrates one example of the configuration of a switched capacitor.

FIG. 8 is a block diagram schematically illustrating an example of the hardware configuration of the electronic apparatus according to one or more embodiments.

### DETAILED DESCRIPTION

The following describes embodiments of the present application, with reference to the drawings. First, the following describes the overview of a power supply circuit 1 according to one or more embodiments of the present application.

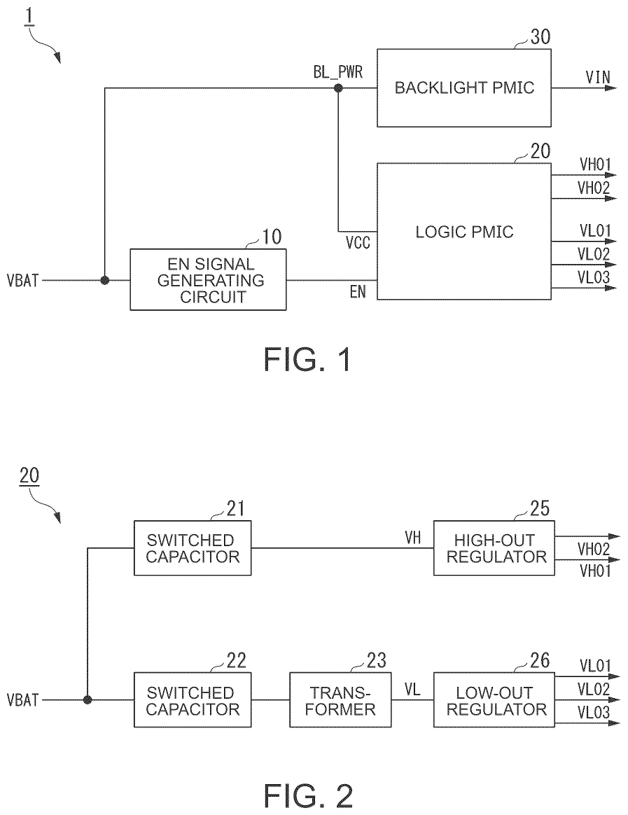

FIG. 1 is a block diagram illustrating one example of the configuration of the power supply circuit 1 according to one or more embodiments.

The power supply circuit 1 illustrated in FIG. 1 is mainly applied to a display unit or an electronic apparatus equipped with a display unit.

The power supply circuit 1 includes an EN signal generating circuit 10, a logic PMIC 20, and a backlight PMIC 30.

The EN signal generating circuit 10 generates an enable (EN) signal from power supplied from a power supply. The EN signal is a control signal for instructing the operation of the logic PMIC 20. The EN signal has a signal voltage significantly higher than 0V (typically 2 to 4V, e.g., 3.3V) and indicates that the logic PMIC 20 is enabled. For instance, the EN signal generating circuit 10 includes a regulator. The regulator converts the power supply voltage VBAT into the signal voltage of the EN signal.

The power supplied from the power supply is also branched and supplied to the logic PMIC 20 and the backlight PMIC 30.

The logic PMIC 20 is a PMIC that supplies power to a logic circuit in the display unit. The logic PMIC 20 is supplied with power from the power supply, and is capable of transforming the input voltage of the supplied power into output voltages at a predetermined plurality of stages. In the example of FIG. 1, the logic PMIC 20 has one power supply terminal, one control terminal and five output terminals. Power is supplied to the power supply terminal from the power supply. An EN signal is input from the EN signal generating circuit 10 to the control terminal. The logic PMIC enables its functions when the EN signal is input, and stops the operation when the EN signal is not input.

The logic PMIC 20 converts one input voltage VCC into five output voltage stage VH01, VH02, VL01, VL02, and VL03. When the value of the input voltage VCC is the rated value of the battery voltage (e.g., 5 V), the values of the output voltages VH01 and VH02 are each set to a value higher than the input voltage VCC (e.g., 10 to 15 V). The values of the output voltages VL01, VL02, and VL03 are each set to a value lower than the input voltage VCC (e.g., 1.2 to 3 V).

The logic PMIC 20 supplies power having individual output voltages to the elements of the electronic apparatus via their output terminals.

The logic PMIC 20 includes one or more switched capacitors and one or more regulators. A switched capacitor is capable of transforming a voltage with one or more transformation ratios, and applies a lower transformation ratio as the input voltage increases. The transformation ratio corresponds to the ratio of the output voltage to the input voltage. The transformation ratio is a general term for the step-up ratio and the step-down ratio. It is capable of transforming the input voltage at a predetermined transformation ratio, and is capable of adjusting the transformation ratio to the transformed voltage according to the input voltage. The regulator adjusts the voltage of the power output from the switched capacitor or further of the intermediate power, which is transformed or branched power, to the output voltages VH01, VH02, VL01, VL02, and VL03 each having a different stage. An example configuration of the logic PMIC 20 is described later.

The backlight PMIC 30 is supplied with power from the power supply. The backlight PMIC 30 is an integrated circuit that receives the input voltage VBAT of the supplied power as an input voltage BL PWR for the backlight and transforms it into an output voltage for the backlight. That is, the backlight PMIC 30 functions as a voltage source for the display unit. The output voltage for the backlight may have a predetermined constant value, or may be variable in response to a command from a controller of the electronic apparatus. The output voltage for backlight may be higher than the input voltage, although one stage is sufficient. The output voltage for the backlight is, for example, 30 to 40V. The backlight PMIC 30 supplies power having a transformed output voltage to the backlight of the display.

Next, the following describes an example of the configuration of the logic PMIC 20 according to one or more embodiments. FIG. 2 is a block diagram illustrating a first configuration example of the logic PMIC 20 according to one or more embodiments.

The logic PMIC 20 according to this configuration example includes switched capacitors 21 and 22, a transformer 23, a high-out regulator 25, and a low-out regulator 26.

The switched capacitor 21 is capable of stepping up the input voltage of the power supplied from the power supply at a predetermined step-up ratio. When an input voltage is lower than a predetermined first reference voltage, the switched capacitor 21 steps up the input voltage and defines the stepped-up voltage as a first intermediate voltage VH. When an input voltage is equal to or higher than the first reference voltage, the switched capacitor 21 does not step up the input voltage and defines it as the first intermediate voltage VH. The switched capacitor 21 outputs first intermediate power that is power having the first intermediate voltage VH to the high-out regulator 25. The switched capacitor 22 is capable of stepping down the input voltage of the power supplied from the power supply at a predetermined step-down ratio. When an input voltage is higher than a predetermined second reference voltage, the switched capacitor 22 steps down the input voltage and defines the stepped-down voltage as a first-stage second intermediate voltage. When an input voltage is equal to or lower than the predetermined second reference voltage, the switched capacitor 22 does not step down the input voltage and defines it as the first-stage second intermediate voltage. The switched capacitor 22 outputs first-stage second intermediate power that is power having the first-stage second intermediate voltage to the transformer 23.

The transformer 23 steps down a second intermediate voltage, which is the voltage of the first-stage second intermediate power input from the switched capacitor 22, at a predetermined transformation ratio. Unlike the switched capacitors 21 and 22, the transformer 23 has a fixed transformation ratio. The transformer 23 outputs second-stage intermediate power having the stepped-down voltage as the second-stage intermediate voltage VL to the low-out regulator 26.

The high-out regulator 25 adjusts the first intermediate voltage VH of the first intermediate power input from the switched capacitor 21 to predetermined output voltages VH01 and VH02. The high-out regulator 25 then outputs the output power having the adjusted output voltages VH01 and VH02 to the components requiring power with these output voltages.

The high-out regulator 25 includes a boost converter, a buck converter, and a charge pump.

The low-out regulator 26 adjusts the second intermediate voltage VL of the second intermediate power input from the transformer 23 to predetermined output voltages VL01, VL02 and VL03. The low-out regulator 26 then outputs the output power having the adjusted output voltages VL01, VL02, and VL03 to the components requiring power with these output voltages. The low-out regulator 26 includes one or more buck converters.

When a battery is used as the power supply, the input voltage VBAT varies greatly with the number of cells and remaining charge of the battery. A cell is a component that makes up a battery. When multiple cells are connected in series in a battery, the input voltage is proportional to the number of cells. The higher the remaining charge, the higher the input voltage VBAT. Typically, the input voltage VBAT is highest when the battery is fully charged. The output voltages at the multiple stages may each be set to a constant value. The output voltages at the multiple stages may include some that are higher than the input voltage, but also some that are lower.

The output voltages VH01 and VH02, which are likely to be higher than the input voltage VBAT, are provided by the high-out regulator 25. The operating parameters of the switched capacitor 21 and the high-out regulator 25 are set so that the input voltage to the high-out regulator 25 is in most cases equal to or greater than the maximum value of the output voltages VH01 and VH02, and so that the first intermediate voltage VH is obtained whose difference from the maximum value is as small as possible. The operating parameters include the step-up ratio of the switched capacitor 21 and the first reference power. In many cases, when the remaining charge of a battery with a relatively small number of cells (e.g., two cells) reaches a lower limit (e.g., 10 to 20%), the first intermediate voltage VH obtained by stepping up with the switched capacitor 21 may be used as a parameter setting condition.

If the input voltage is significantly lower than the output voltages VH01 and VH02, a transformer (not illustrated) may be provided downstream of the switched capacitor 21. The transformer steps up the power supplied from the switched capacitor 21 and supplies the stepped-up power to the high-out regulator. In that case, the voltage of the power stepped up by the switched capacitor 21 may be the first intermediate voltage VH, and the step-up ratio, the parameter of the transformer, may be further set based on the aforementioned standard.

The output voltages VL01, VL02, and VL03, which are likely to be lower than the input voltage VBAT, are provided by the low-out regulator 26. The operating parameters of the switched capacitor 22, the transformer 23 and the low-out regulator 26 are set so that the input voltage to the low-out regulator 26 is in most cases equal to or greater than the maximum value of the output voltages VL01, VL02, and VL03, and so that the second intermediate voltage VL is obtained whose difference from the maximum value is as small as possible. The operating parameters include the step-down ratio of the switched capacitor 22, the second reference power, and the step-down ratio of the transformer 23. For example, when the remaining charge of a battery with a predetermined number of cells (e.g., four cells) reaches an upper limit, the second intermediate voltage VL obtained by stepping down with the switched capacitor 22 may be used as a parameter setting condition.

If the difference between the input voltage and the output voltages VL01, VL02, and VL03 is smaller, the transformer 23 may be omitted. In this case, the power output from the switched capacitor 22 is directly supplied to the low-out regulator 26, so that the voltage of the power supplied by the switched capacitor 22 may be the second intermediate voltage VL, and the operating parameters of the switched capacitor 22 and the low-out regulator 26 may be set based on the aforementioned standard.

Next, the following describes a second example of the configuration of the logic PMIC 20 according to one or more embodiments. The following description will focus mainly on the differences from the first configuration example. Configurations common to those of the first configuration example are designated with common reference numerals, and their explanation will be applied unless otherwise specified.

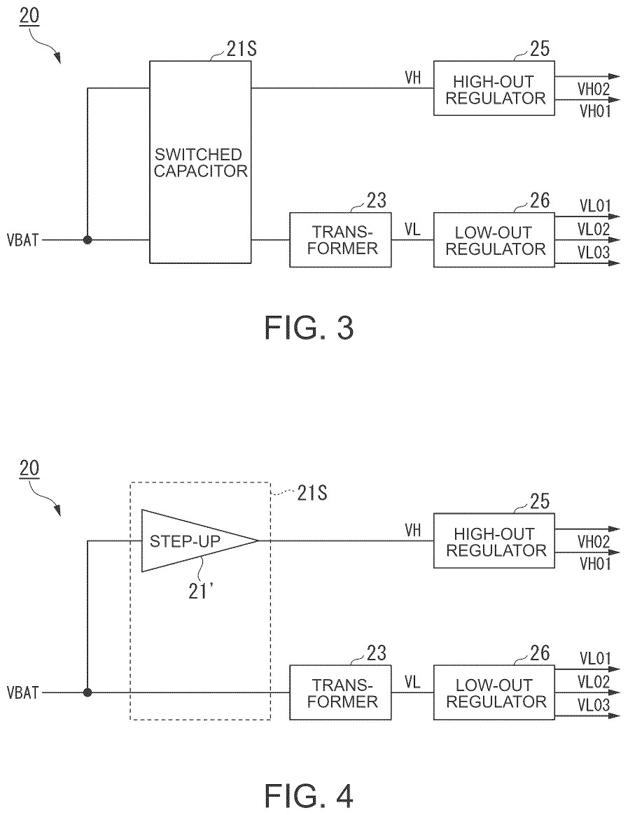

FIG. 3 is a block diagram illustrating a second configuration example of the logic PMIC 20 according to one or more embodiments.

The logic PMIC 20 according to this configuration example includes a switched capacitors 21S, a transformer 23, a high-out regulator 25, and a low-out regulator 26. That is, the logic PMIC 20 of this configuration differs in that it has the switched capacitor 21S instead of the switched capacitors 21 and 22.

The switched capacitor 21S is capable of changing three states, including step-up, step-down, and pass, in accordance with the input voltage VBAT. When the input voltage VBAT is lower than a first reference voltage, the switched capacitor 21S steps up the input voltage VBAT supplied from the power supply at a predetermined step-up ratio, supplies a first intermediate power having the stepped-up voltage as an intermediate voltage VH to the high-out regulator 25, and supplies a first-stage second intermediate power that maintains the input voltage VBAT unchanged to the transformer 23.

When the input voltage VBAT is equal to or higher than the first reference voltage and is equal to or lower than a second reference voltage, the switched capacitor 21S branches the power, which maintains the input voltage VBAT without changing, into a first intermediate power and a first-stage second intermediate power, supplies the first intermediate power to the high-out regulator 25, and supplies the first-stage second intermediate power to the transformer 23.

When the input voltage VBAT is higher than the second reference voltage, the switched capacitor 21S steps down the input voltage VBAT supplied from the power supply at a predetermined step-down ratio, supplies a first-stage second intermediate power having the stepped-down voltage to the transformer 23, and supplies a first intermediate power that maintains the input voltage VBAT unchanged to the high-out regulator 25.

When the power supply is a battery, the switched capacitors 21, 22, or the switched capacitor 21S may use the configuration of the battery as an index value of the input voltage VBAT when determining whether conversion of the input voltage VBAT is necessary or whether to step up, step down, or pass the input voltage VBAT. The battery may include multiple cells, which may be connected in series. The output voltage of the power discharged from the battery is proportional to the number of cells connected in series (this may be referred to as the “cell number” in this application). For the switched capacitors 21 and 22 or switched capacitor 21S, the cell number may be used as the information of the battery configuration. For example, the battery notifies the switched capacitors 21 and 22 or switched capacitor 21S of the configuration information indicating its cell number using a specified communication method.

Next, the following describes an operation example of the logic PMIC 20 according to the second configuration example, using the following conditions as an example. The switched capacitor 21S determines the input voltage based on the cell number, which indicates the configuration of the battery. The input voltage is variable within the range of 2S to 4S. S indicates the rated voltage of one cell. Typically, 1S is 2.5 to 5 V. Both output voltages VH01 and VH02 are higher than 2S. The maximum output voltages VH01 and VH02 are higher than 3S. Output voltages VL01, VL02, and VL03 are all lower than 2S.

The step-up ratio and step-down ratio of the switched capacitor 21S and the step-down ratio of the transformer 23 are 1:2, 2:1, and 2:1, respectively. The first reference voltage and the second reference voltage are 2.5S and 3.5S, respectively.

FIG. 4 to FIG. 6 illustrate examples of the operation of the switched capacitor 21S. FIG. 4 illustrates the behavior of the switched capacitor 21S when the cell number is two, that is, the input voltage VBAT is 2S.

In this case, the switched capacitor 21S steps up the input voltage VBAT supplied from the power supply at a step-up ratio of 1:2 and supplies the first intermediate power having the stepped-up voltage as intermediate voltage VH to the high-out regulator 25.

The input voltage VBAT is lower than the second reference voltage. Thus, the switched capacitor 21S does not step down the input voltage VBAT and passes the power supplied from the power supply to the transformer 23 as the first-stage second intermediate power.

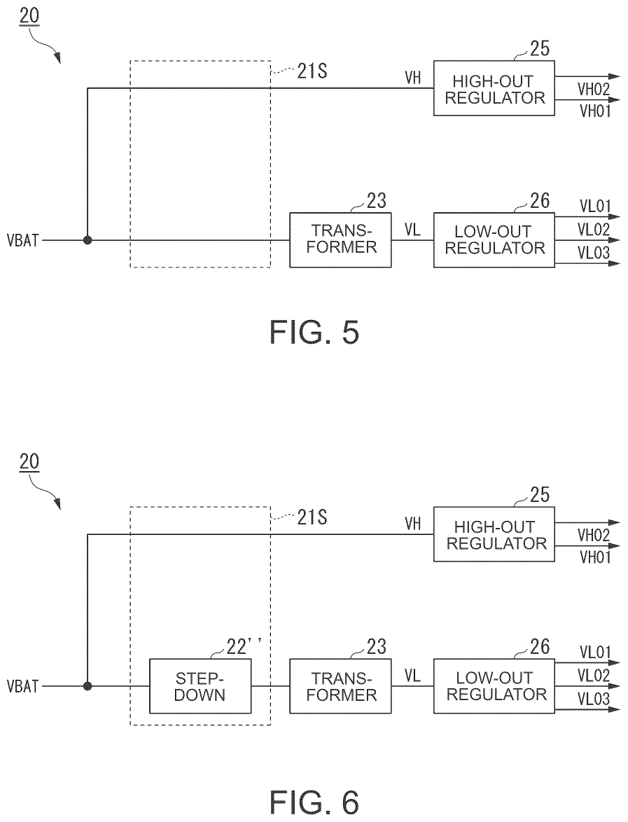

FIG. 5 illustrates the behavior of the switched capacitor 21S when the cell number is three, that is, the input voltage VBAT is 3S.

In this case, the switched capacitor 21S does not step down the input voltage VBAT, and passes the power supplied from the power supply to the high-out regulator 25 as the first intermediate power.

The switched capacitor 21S does not step down the input voltage VBAT and passes the power supplied from the power supply to the transformer 23 as the first-stage second intermediate power.

FIG. 6 illustrates the behavior of the switched capacitor 21S when the cell number is four, that is, the input voltage VBAT is 4S.

In this case, the switched capacitor 21S does not step down the input voltage VBAT, and passes the power supplied from the power supply to the high-out regulator 25 as the first intermediate power.

The switched capacitor 21S steps down the input voltage VBAT supplied from the power supply at a step-down ratio of 2:1, and supplies the power with the stepped-down voltage to the transformer 23 as the first-stage second intermediate power.

The logic PMIC 20 that includes the switched capacitors 21 and 22 as in the first configuration example also achieves the same actions and advantageous effects as the example including the switched capacitor 21S.

That is, the switched capacitor 21 in the example of FIG. 4 steps up the input voltage VBAT supplied from the power supply at a step-up ratio of 1:2 and supplies the first intermediate power having the stepped-up voltage as intermediate voltage VH to the high-out regulator 25. The switched capacitor 22 does not step down the input voltage VBAT and passes the power supplied from the power supply to the transformer 23 as the first-stage second intermediate power.

In the example of FIG. 5, the switched capacitor 21 does not step down the input voltage VBAT, and passes the power supplied from the power supply to the high-out regulator as the first intermediate power. The switched capacitor 21S does not step down the input voltage VBAT and passes the power supplied from the power supply to the transformer 23 as the first-stage second intermediate power.

In the example of FIG. 6, the switched capacitor 21S does not step down the input voltage VBAT, and passes the power supplied from the power supply to the high-out regulator 25 as the first intermediate power.

The input voltage VBAT is higher than the second reference voltage, and thus the switched capacitor 22 steps down the input voltage VBAT supplied from the power supply at a step-down ratio of 2:1, and supplies the power with the stepped-down voltage to the transformer 23 as the first-stage second intermediate power.

In this way, the switched capacitors 21 and 22 or the switched capacitor 21S changes the necessity for stepping up or stepping down, depending on the input voltage VBAT or the configuration of the battery. The voltage obtained by stepping up the input voltage VBAT becomes closer to the higher output voltages VH01 and VH02 or exceeds the output voltages VH01 and VH02. This avoids or suppresses the stepping-up of voltage in the high-out regulator 25, thus avoiding or suppressing a decrease in efficiency due to the voltage stepping-up. In this regard, the switched capacitor 21 is capable of stepping up the input voltage VBAT with high efficiency (e.g., 97 to 99%), and thus the efficiency of the logic PMIC 20 as a whole improves.

The stepping-down brings the input voltage VBAT closer to the lower output voltages VL01, VL02, and VL03. Thus, the difference between the input voltage and output voltage is reduced also in the low-out regulator 26, which also reduces the efficiency loss. Accordingly, the efficiency of the logic PMIC 20 as a whole improves.

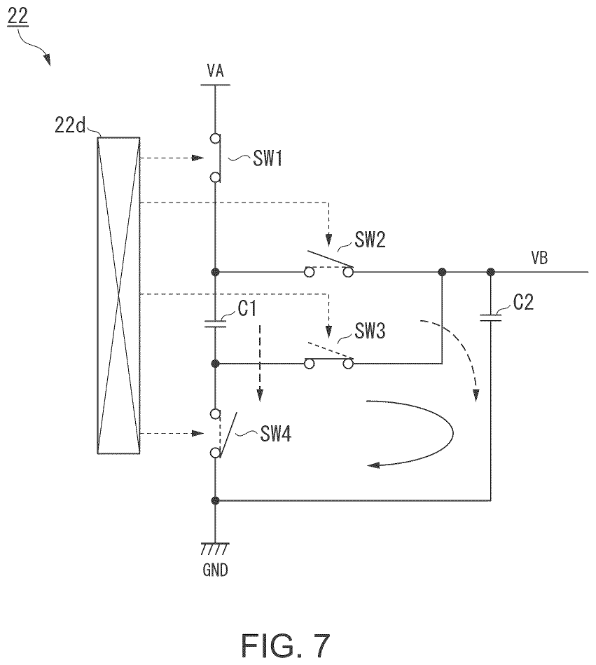

Next, the following describes an example of the configuration of the switched capacitor 22 according to one or more embodiments. FIG. 7 illustrates one example of the configuration of the switched capacitor 22. The switched capacitor 22 includes capacitive elements C1 and C2, switching elements SW1 to SW4, and a drive circuit 22d. With this configuration, the switched capacitor 22 is capable of stepping down the input voltage at a step-down ratio of 2:1. The capacitive elements C1 and C2 are, for example, capacitors. The capacitances of the capacitive elements C1 and C2 may be equal to each other or may be different from each other. The switching elements SW1-SW4 are, for example, metal-oxide-semiconductor field-effect transistors (MOSFETs).

Power is supplied to the input terminal VA from the power supply. The output terminal VB may be supplied with stepped-down power or the power supplied from the power supply without stepping down.

The switching element SW1 has one end connected to the input terminal VA, and the other end connected to one end of the capacitive element C1 and one end of the switching element SW2.

The switching element SW2 has one end connected to the other end of the switching element SW1 and one end of the capacitive element C1, and the other end connected to one end of the capacitive element C2, the other end of the switching element SW3 and the output terminal VB.

The switching element SW3 has one end connected to the other end of the capacitive element C3 and one end of the switching element SW4, and the other end connected to the other end of the switching element SW2, one end of the capacitive element C2 and the output terminal VB.

The switching element SW4 has one end connected to the other end of the capacitive element C1 and one end of the switching element SW3, and the other end connected to the potential reference point GND and the other end of capacitive element C2.

When the switching elements SW1, SW2, SW3, and SW4 are respectively turned ON (closed), OFF (open), ON (closed), and OFF (open), the capacitive elements C1 and C2 are connected in series between the input terminal VA and the potential reference point GND. At this time, a voltage divided between the input terminal VA and the potential reference point GND is applied to the capacitive elements C1 and C2, so that charges are accumulated.

When the switching elements SW1, SW2, SW3, and SW4 are respectively turned ON (closed), ON (closed), OFF (open), and ON (closed), the capacitive elements C1 and C2 are connected in parallel between the input terminal VA and the potential reference point GND. At this time, the accumulated charge is discharged from one end of each of the capacitive elements C1 and C2.

When the input voltage is higher than the second reference voltage, the drive circuit 22d controls the states of the switching elements SW1, SW2, SW3, and SW4 so that the capacitive elements C1 and C2 are switched between connected in series and connected in parallel at a constant period. Thus, power having an output voltage that is a voltage stepped down from the input voltage at a step-down ratio of 2:1 is output from the output terminal VB.

When the input voltage is equal to or lower than the second reference voltage, the drive circuit 22d controls the states of the switching elements SW1, SW2, SW3, and SW4 so that the capacitive elements C1 and C2 are fixed to be connected in parallel. This connects the input terminal VA and the output terminal VB and puts the capacitive elements C1 and C2 between them and the potential reference point GND, and thus the input voltage is not stepped down and the supplied power is output.

The switched capacitor 22 illustrated in FIG. 7 alternately changes the connecting state of the two capacitive elements between in series and in parallel by turning on and off with the switching elements, so as to step down the input voltage at a step-down ratio of 2:1. The present invention is not limited to this configuration. The switched capacitor 22 may include M (any preset integer equal to or greater than 2) capacitive elements, and may be configured to alternately change the connection states of M pieces of capacitive elements between in series and in parallel so as to step down the voltage at a step-down ratio of M:1.

The switched capacitor 21 is configured so that, if the input voltage is lower than the first reference voltage, the input/output relationship of power for the switched capacitor 22 illustrated in FIG. 7 is inverted, thus changing the connection state of the capacitive elements C1 and C2, and if the input voltage is equal to or higher than the first reference voltage, the connection state of the capacitive elements C1 and C2 are fixed to be connected in parallel. Such a change in connection state of the capacitive elements C1 and C2 achieves the stepping-up of a voltage with a step-up ratio of 1:2. The inversion of the input/output relationship means that power supplied from the power supply is input to a terminal corresponding to the output terminal VB in FIG. 6, and power without steeping up or stepping down is output from a terminal corresponding to the input terminal VA.

The switched capacitor 21S is implemented by combining changing of the input/output relationship and changing of the connection state of the capacitive elements in the switched capacitor 22 illustrated in FIG. 7. This configuration allows changing between a total of three states: stepping up, stepping down, and passing. The step-up ratio for step-up is the reciprocal of the step-down ratio for step-down.

In one or more embodiments, each of the switched capacitors 21, 21S, and 22 may be configured as a single integrated circuit, or may be configured to include two or more circuits, elements, or a combination thereof. Any one of the switched capacitors 21, 21S, and 22, or any combination thereof, may be configured as a power supply circuit. The switched capacitors 21, 21S, and 22 themselves may be used as a part or the whole of a power supply circuit of an electronic apparatus, to which power can be supplied. For example, for some types of electronic apparatuses without the display 44 or some types of display, the backlight PMIC 30 may not be necessary.

Next, the following describes an example of the configuration of the electronic apparatus according to one or more embodiments.

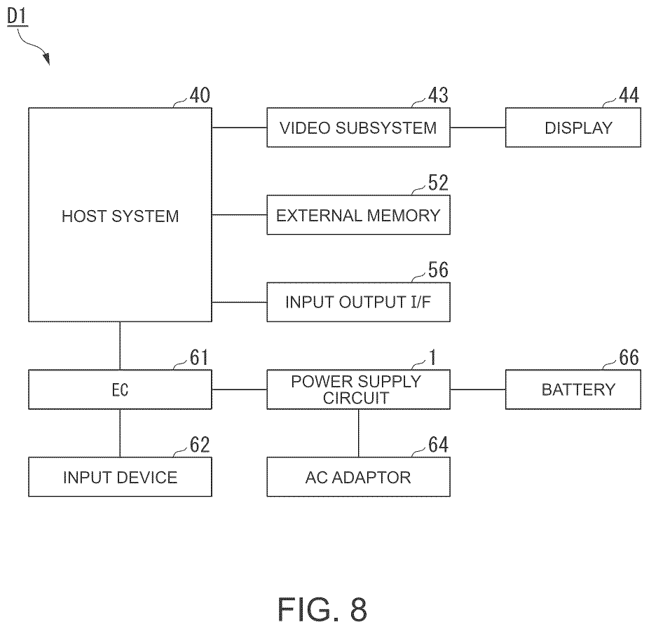

FIG. 8 is a block diagram schematically illustrating one example of the configuration of the electronic apparatus D1 according to one or more embodiments. The electronic apparatus D1 is configured as, but not limited to, a general-purpose personal computer (PC). The electronic apparatus D1 includes a host system 40, a video subsystem 43, a display 44, an external memory 52, an input/output (I/F) 56, an embedded controller (EC) 61, an input device 62, a power supply circuit 1, a battery 66, and an alternating current (AC) adaptor 67.

The host system 40 is the core computer system of the electronic apparatus D1. The host system 40 includes a processor, a main memory, and a chipset.

The processor executes various types of processing designated by an instruction described in programs. For instance, the processor includes one or more central processing units (CPUS). The main memory is a writable memory functioning as a read-in area of a program executed by the processor or a work area to write the data processed by the executed program.

The chipset connects to the host system 40 and other devices by wire, and controls the input and output of various types of data.

The video subsystem 43 processes drawing commands from the host system 40, and outputs to the display 44 display data indicating various types of display information obtained by the processing.

The display 44 displays a display screen based on the display data output from the video subsystem 43.

The external memory 52 stores various types of data in a rewritable and persistent manner. The stored data includes various programs, parameters, data used in various processes, and data obtained by various processes. The external memory 52 may be either a hard disk drive (HDD) or a solid state drive (SSD), for example. The input/output I/F 56 connects to other devices by wire or wirelessly to enable exchanging of various types of data. The connection with other devices may be via a communication network.

The EC 61 is a one-chip microcomputer to monitor and control various devices (e.g., peripherals and sensors), irrespective of the operating state of the host system 40. The EC 61 is connected to the input device 62 and the power supply circuit 1, and is capable of controlling the operations of these.

The input device 62 detects an operation by a user, and outputs an operation signal corresponding to the detected operation to the EC 61. The input device 62 includes a keyboard and a touch pad.

The power supply circuit 1 converts the voltage of DC power supplied from the AC adaptor 64 or the battery 66 into a voltage required for the operation of each device that constitutes the electronic apparatus D1, and supplies the power having the converted voltage to the device. The power supply circuit 1 performs power supply under the control of the EC 61. When power is supplied from the AC adapter 64, the power supply circuit 1 stores in the battery 66 the remaining power that is not supplied to each device. If power is not supplied from the AC adapter 64, or if the power supplied from the AC adapter 64 is insufficient, the power discharged from the battery 66 is supplied to each device as the operating power.

The AC adapter 64 converts AC power supplied from an external power supply into DC power with constant voltage and supplies the converted power to the power supply circuit 1.

The battery 66 has a secondary battery. A secondary battery is a storage battery that can be both charged and discharged. Examples of the secondary battery include a lithium-ion battery.

As described above, the power supply circuit 1 according to one or more embodiments converts a single input voltage to an output voltage at multiple stages, and includes: one or more switched capacitors (e.g., switched capacitors 21, 21S, 22) capable of transforming an input voltage at one or more transformation ratios and applying a lower transformation ratio as the input voltage increases; and one or more regulators (e.g., high-out regulator 25 and low-out regulator 26) that adjust an intermediate voltage based on the output power from the switched capacitor to the output voltage.

The input voltage may be the discharge voltage of the battery, and the switched capacitors may have a transformation ratio defined based on the battery configuration.

With this configuration, even if the input voltage varies, the output voltage from the switched capacitor is leveled. The intermediate voltage input to the regulator is based on the output voltage from the switched capacitor, so that the difference with the output voltage is reduced. Therefore, the voltage conversion efficiency of the entire power supply circuit 1 including the regulator improves.

The one or more switched capacitors may include a first switched capacitor (e.g., switched capacitor 21) capable of stepping up an input voltage at a predetermined step-up ratio, and a second switched capacitor (e.g., switched capacitor 22) capable of stepping down the input voltage at a predetermined step-down ratio. The first switched capacitor steps up the input voltage when the input voltage is lower than a first reference voltage, and the second switched capacitor steps down the input voltage when the input voltage is higher than a second reference voltage. The one or more regulators include: a first regulator (e.g., high-out regulator 25) that adjusts the first intermediate voltage based on the first output power from the first switched capacitor to the first output voltage, which is part of the output voltage; and a second regulator (e.g., low-out regulator 26) that adjusts the second intermediate voltage based on the second output power from the second switched capacitor to the second output voltage, which is another part of the output power.

The input voltage may be the discharge voltage of the battery, and the first reference voltage or the second reference voltage may be set based on the discharge voltage when the battery has a predetermined reference remaining charge.

With this configuration, the first regulator for adjusting to the first output voltage can be used separately from the second regulator for adjusting to the lower second output voltage. To obtain a first intermediate voltage to be supplied to the first regulator, when the input voltage is lower than the first reference voltage, the input voltage to the first regulator is stepped up; and to obtain a second intermediate voltage to be supplied to the second regulator, when the input voltage is higher than the second reference voltage, the input voltage to the second regulator is stepped down. This further reduces the difference between the input voltage and the output voltage of each regulator, which improves the voltage conversion efficiency.

With this configuration, when the input voltage, which depends on the remaining charge of the battery, is lower than the first reference voltage, the first switched capacitor starts stepping-up the voltage, and when the input voltage is equal to or lower than the second reference voltage, the second switched capacitor stops stepping down the voltage. This further reduces the difference between the input voltage and the output voltage of each regulator, which further improves the voltage conversion efficiency.

The power supply circuit according to one or more embodiments may be configured as an integrated circuit (e.g., a PMIC) that includes one or more switched capacitors and one or more regulators that are integrated.

One or more embodiments may also be configured as the electronic apparatus D1 including the battery 66 and a power supply circuit.

Although the embodiments of the present application have been described in detail with reference to the drawings, the specific configuration of the present application is not limited to the above-described embodiments, and also includes design modifications or the like within the scope of the present invention. The configurations described in the above embodiments can be combined freely.

### DESCRIPTION OF SYMBOLS

1 power supply circuit
10 EN signal generating circuit
20 logic PMIC
21, 21S, 22 switched capacitor
22d drive circuit
23 transformer
25 high-out regulator
26 low-out regulator
30 backlight PMIC
40 host system
43 video subsystem
44 display
52 external memory
56 input/output I/F
61 EC
62 input device
64 AC adapter
66 battery
C1, C2 capacitive element
D1 electronic apparatus
SW1, SW2, SW3, SW4 switching element

What is claimed is:

1. A power supply circuit that converts a single input voltage to a multi-stage output voltage, comprising:
one or more switched capacitors capable of transforming the input voltage at one or more transformation ratios and applying a lower transformation ratio as the input voltage increases; and
one or more regulators that adjust an intermediate voltage based on an output power from each of the switched capacitors to the output voltage.

2. The power supply circuit according to claim 1, wherein the one or more of switched capacitors include:
a first switched capacitor capable of stepping up the input voltage at a predetermined step-up ratio; and
a second switched capacitor capable of stepping down the input voltage at a predetermined step-down ratio, wherein
the first switched capacitor steps up the input voltage when the input voltage is lower than a predetermined first reference voltage, and
the second switched capacitor steps down the input voltage when the input voltage is higher than a predetermined second reference voltage, and
the one or more of regulators include:
a first regulator that adjusts a first intermediate voltage based on a first output power from the first switched capacitor to a first output voltage as a part of the output voltage; and
a second regulator that adjusts a second intermediate voltage based on a second output power from the second switched capacitor to a second output voltage as another part of the output voltage.

3. The power supply circuit according to claim 1, wherein the input voltage is a discharge voltage of a battery, and
each of the switched capacitors sets the transformation ratio based on a configuration of the battery.

4. The power supply circuit according to claim 2, further comprising:
a step-down converter that steps down a second output power from the second switched capacitor, or
a step-up converter that steps up a first output power from the first switched capacitor.

5. The power supply circuit according to claim 1, wherein the one or more of switched capacitors and the one or more regulators are integrated.

6. An electronic apparatus comprising: a battery; and the power supply circuit according to claim 1.
